(19) United States
(12) Patent Application Publication
(10) Pub. No.: US 2011/0069212 A1
(43) Pub. Date: Mar. 24, 2011

(54) IMAGE PICKUP LENS, IMAGE PICKUP MODULE, METHOD FOR MANUFACTURING IMAGE PICKUP LENS, AND METHOD FOR MANUFACTURING IMAGE PICKUP MODULE

(76) Inventors: Norimichi SHIGEMITSU, Osaka-shi (JP); Hiroyuki Hanato, Osaka-shi (JP)

(21) Appl. No.: 12/887,639

(22) Filed: Sep. 22, 2010

(30) Foreign Application Priority Data
Sep. 24, 2009 (JP) 2009-218673
Oct. 16, 2009 (JP) 2009-239764

(51) Int. Cl. H04N 5/335; G02B 13/18; B32B 37/16

(52) U.S. Cl. 348/294; 359/717; 156/242; 348/E05.091

(57) ABSTRACT

In order that an image pickup lens etc. may be realized which make it possible to easily realize an arrangement which reduces a possibility of deterioration of an optical characteristic, and which is suitable for a reduction in manufacturing costs and for mass-production, an image pickup lens of the present invention satisfies the following formulas (1) and (2);

1.0<d1/d12<1.8 (1); and

0.1<d′12/(d1+d2) (2)

where: d1 is a distance between a center of that surface of a first lens which faces an object and a center of that surface of the first lens which faces an image surface; d12 is a distance between the center of that surface of the first lens which faces the image surface and a center of that surface of a second lens which faces the object; d2 is a distance between the center of that surface of the second lens which faces the object and a center of that surface of the second lens which faces the image surface; and d′12 is a clearance, along a direction of an optical axis of the image pickup lens, between an end of that surface of the first lens which faces the image surface and an end of that surface of the second lens which faces the object.

This Nonprovisional application claims priority under 35 U.S.C. §119(a) on Patent Application No. 2009-218673 filed in Japan on Sep. 24, 2009 and Patent Application No. 2009-239764 filed in Japan on Oct. 16, 2009, the entire contents of which are hereby incorporated by reference.

### TECHNICAL FIELD

The present invention relates to: an image pickup lens and an image pickup module that are to be provided in a portable terminal; a method for manufacturing an image pickup lens; and a method for manufacturing an image pickup module.

### BACKGROUND ART

As image pickup modules, various types of compact digital cameras, compact digital video units, and the like have been developed each of which houses a solid-state image sensing device such as a CCD (Charge Coupled Device) and a CMOS (Complementary Metal Oxide Semiconductor). In particular, portable terminals such as portable information terminals and portable phones have spread in recent years. Accordingly, image pickup modules to be provided in the portable terminals are required to be small in size, low in height, and, needless to say, high in resolving power.

A technique for reducing a size and a height of an image pickup lens to be provided in such an image pickup module attracts attention, as a technique for satisfying such demands for a small size and a low height. As one example of such a technique, Patent Literatures 1 and 2 disclose respective image pickup lenses having the following arrangement.

Each of the image pickup lenses disclosed in Patent Literatures 1 and 2 has an aperture stop, a first lens, and a second lens which are provided in this order from an object (subject) side to an image surface (image forming surface) side. The first lens is a meniscus lens which has a positive refracting power and whose convex surface faces the object side. The second lens is a lens whose both sides respectively facing the object side and the image surface side are concave surfaces.

In order that without having an additional lens, the image pickup lens disclosed in Patent Literature 1 may be compact and satisfactorily correct an aberration, the image pickup lens is further arranged so as to satisfy the following formulas (X) and (Y):

0.6<f1/f<1.0 (X); and

1.8<(n1−1)f/r1<2.5 (Y),

where f is a focal length of a lens system; f1 is a focal length of the first lens; n1 is a refractive index of the first lens; and r1 is a curvature radius of that convex surface of the first lens which faces the object.

On the other hand, the image pickup lens disclosed in Patent Literature 1 is not sufficiently small.

In view of this, in order that a small image pickup lens may be realized which has a good optical characteristic and which is made up of two lenses, the image pickup lens disclosed in Patent Literature 2 is arranged, with use of the second lens having a negative refracting power, to satisfy the following formulas (A) to (C):

0.8<v1/v2<1.2 (A);

50<v1 (B); and

1.9<d1/d12<2.8 (C),

where v1 is an Abbe number of the first lens; v2 is an Abbe number of the second lens; d1 is a center thickness of the first lens; and d12 is a distance from that concave surface of the first lens which faces an image surface to that concave surface of the second lens which faces an object.

### CITATION LIST

Patent Literature 1

Japanese Patent Application Publication, Tokukai, No. 2006-178026 A (Publication Date: Jul. 6, 2006)

Patent Literature 2

Japanese Patent Application Publication, Tokukai, No. 2008-309999 A (Publication Date: Dec. 25, 2008)

Patent Literature 3

Japanese Patent Application Publication, Tokukai, No. 2009-018578 A (Publication Date: Jan. 29, 2009)

Patent Literature 4

Japanese Patent Application Publication, Tokukai, No. 2009-023353 A (Publication Date: Feb. 5, 2009)

### SUMMARY OF INVENTION

### Technical Problem

The image pickup lens disclosed in Patent Literature 2 satisfies the formula (C). This decreases a proportion, to the center thickness d1 of the first lens, of the distance d12 which is a distance between the image-side surface of the first lens and the object-side surface of the second lens. This leads to a very small distance between the first lens and the second lens. As a result, there arises a difficulty in providing both the edge portions of the first and second lenses.

As one example, the following deals with a problem that an image pickup lens can have in a case where its second lens has no edge portion. Note that the same problem can also arise in a case where its first lens has no edge portion.

The image pickup lens whose second lens has no edge portion has a difficulty in securing an appropriate aspheric characteristic of the second lens, in contrast to an image pickup lens whose second lens has its edge portion. The lack of the appropriate aspheric characteristic can lead to deterioration of an optical characteristic of the image pickup lens.

As a method for manufacturing an image pickup lens, there has been proposed a manufacturing process called wafer-level lens process, with the aim of a reduction in manufacturing costs (see Patent Literatures 3 and 4). A wafer-level lens process is a manufacturing process which is performed as below. First, a molding material (resin or the like) is molded or shaped into a plurality of lenses, thereby fabricating an array of lenses (also referred to as wafer lens). A plurality of arrays of lenses are thus prepared. The arrays of lenses are bonded to each other, and finally, divided into separate image pickup lenses. The manufacturing process makes it possible to manufacture a large number of image pickup lenses at a time in a short time. This allows a reduction in manufacturing costs of the image pickup lenses.

It is very difficult to fabricate an array of lenses which has a plurality of second lenses having no edge portion. Accordingly, it is difficult to manufacture, in a wafer-level lens process, an image pickup lens having such a second lens. Therefore, such an image pickup lens is unsuitable for a reduction in manufacturing costs and for mass-production.

The present invention was made in view of the problem. An object of the present invention is to provide an image pickup lens, an image pickup module, a method for manufacturing an image pickup lens, and a method for manufacturing an image pickup module each of which makes it possible to easily realize an arrangement which reduces a possibility of deterioration of an optical characteristic, and which is suitable for a reduction in manufacturing costs and for mass-production.

### Solution to Problem

In order to attain the object, an image pickup lens of the present invention includes: an aperture stop; a first lens; and a second lens, the aperture stop, the first lens, and the second lens being arranged in this order along a direction from an object to an image surface, the first lens being a meniscus lens having a positive refracting power and having a convex surface facing the object, the second lens being a lens having a negative refracting power and having a concave surface facing the object, the second lens having a surface facing the image surface, the surface including a concave central portion and a convex peripheral portion surrounding the concave central portion, said image pickup lens satisfying formulas (1) and (2):

1.0<d1/d12<1.8 (1); and

0.1<d′12/(d1+d2) (2)

where: d1 is a distance between a center of that convex surface of the first lens which faces the object and a center of that surface of the first lens which faces the image surface; d12 is a distance between the center of that surface of the first lens which faces the image surface and a center of that concave surface of the second lens which faces the object; d2 is a distance between the center of that concave surface of the second lens which faces the object and a center of that surface of the second lens which faces the image surface; and d′12 is a clearance, along a direction of an optical axis of the image pickup lens, between an end of that surface of the first lens which faces the image surface and an end of that concave surface of the second lens which faces the object.

According to the arrangement, the image pickup lens satisfies the formula (1). This makes it possible to increase a proportion, to d1 which is a center thickness of the first lens, of d12 which is a distance between the image-side surface of the first lens and the object-side surface of the second lens. This make it possible to increase a distance between the first lens and the second lens.

In addition, the image pickup lens satisfies the formula (2). This makes it possible to increase a proportion, to a sum of d1 and d2 which is a center thickness of the second lens, of d′12 which is a clearance (distance along a direction of an optical axis of the image pickup lens) between the end of the image-side surface of the first lens and the end of the object-side surface of the second lens. This makes it possible to secure a sufficiently long distance between the first lens and the second lens in that space near the end of the second lens which lies in a direction normal to the optical axis of the second lens and in which respective edge portions of the first lens and the second lens are to be provided.

The arrangement makes it possible to easily provide both the edge portions in the image pickup lens. This makes it possible to easily realize an arrangement which reduces a possibility of deterioration of an optical characteristic, and which is suitable for a reduction in manufacturing costs and for mass-production.

Further, the image pickup module of the present invention includes: the image pickup lens; and a solid-state image sensing device provided on an image surface of the image pickup lens.

The arrangement make it possible to realize an image pickup module which produces the same effect as the image pickup lens of the present invention.

Further, a method of the present invention for manufacturing an image pickup lens is that for manufacturing the image pickup lens of the present invention. The method includes the steps of: molding a piece of a molding material into an array of first lenses, the array having portions molded as a plurality of the first lenses; molding another piece of the molding material into an array of second lenses, the array having portions molded as a plurality of the second lenses; bonding the array of first lenses to the array of second lenses so that an optical axis of each of the plurality of the first lenses and an optical axis of a corresponding one of the plurality of the second lenses may match one same straight line; and dividing the array of first lenses and the array of second lenses thus bonded to each other into separate image pickup lenses.

Further, a method of the present invention for manufacturing an image pickup module is that for manufacturing the image pickup module of the present invention. The method includes the steps of: molding a piece of a molding material into an array of first lenses, the array having portions molded as a plurality of the first lenses; molding another piece of the molding material into an array of second lenses, the array having portions molded as a plurality of the second lenses; bonding the array of first lenses to the array of second lenses so that an optical axis of each of the plurality of the first lenses and an optical axis of a corresponding one of the plurality of the second lenses may match one same straight line; and dividing the array of first lenses and the array of second lenses thus bonded to each other into separate image pickup modules.

According to the arrangement, first, two pieces of the molding material are molded into the array of first lenses and the array of second lenses, respectively. Then, the arrays are bonded to each other. Finally, the arrays thus bonded to each other are divided into separate image pickup lenses or into separate image pickup modules. Thus, each of the manufacturing methods of the present invention corresponds to a waver-level lens process. This makes it possible to reduce manufacturing costs particularly in the case of mass-production.

### Advantageous Effects of Invention

As described above, an image pickup lens of the present invention includes: an aperture stop; a first lens; and a second lens, the aperture stop, the first lens, and the second lens being arranged in this order along a direction from an object to an image surface, the first lens being a meniscus lens having a positive refracting power and having a convex surface facing the object, the second lens being a lens having a negative refracting power and having a concave surface facing the object, the second lens having a surface facing the image surface, the surface including a concave central portion and a convex peripheral portion surrounding the concave central portion, said image pickup lens satisfying formulas (1) and (2):

1.0<d1/d12<1.8 (1); and

0.1<d′12/(d1+d2) (2)

where: d1 is a distance between a center of that convex surface of the first lens which faces the object and a center of that surface of the first lens which faces the image surface; d12 is a distance between the center of that surface of the first lens which faces the image surface and a center of that concave surface of the second lens which faces the object; d2 is a distance between the center of that concave surface of the second lens which faces the object and a center of that surface of the second lens which faces the image surface; and d′12 is a clearance, along a direction of an optical axis of the image pickup lens, between an end of that surface of the first lens which faces the image surface and an end of that concave surface of the second lens which faces the object.

Thus, the image pickup lens of the present invention makes it possible to easily realize an arrangement which reduces a possibility of deterioration of an optical characteristic, and which is suitable for a reduction in manufacturing costs and for mass-production.

### BRIEF DESCRIPTION OF DRAWINGS

FIG. 1

FIG. 1 is a cross-sectional view illustrating an arrangement of an image pickup lens of the present invention.

FIG. 2

(a) through (c) of FIG. 2 are graphs showing characteristic of various aberrations of the image pickup lens of FIG. 1. (a) shows a characteristic of a spherical aberration. (b) shows a characteristic of astigmatism. (c) shows a characteristic of a distortion.

FIG. 3

FIG. 3 is a cross-sectional view illustrating an arrangement of an image pickup module of the present invention.

FIG. 4

FIG. 4 is a cross-sectional view illustrating an arrangement of another image pickup module of the present invention.

FIG. 5

(a) through (d) of FIG. 5 are cross-sectional views illustrating a method for manufacturing an image pickup lens and an image pickup module of the present invention.

FIG. 6

(a) through (e) of FIG. 6 are cross-sectional views illustrating another method for manufacturing an image pickup lens and an image pickup module of the present invention.

FIG. 7

FIG. 7 is a table which shows, for each of thermoplastic resin and thermosetting resin, relationships between refractive indexes and Abbe numbers of an image pickup lens as a whole on d-rays.

FIG. 8

FIG. 8 is a graph showing the relationships shown in FIG. 7.

### DESCRIPTION OF EMBODIMENTS

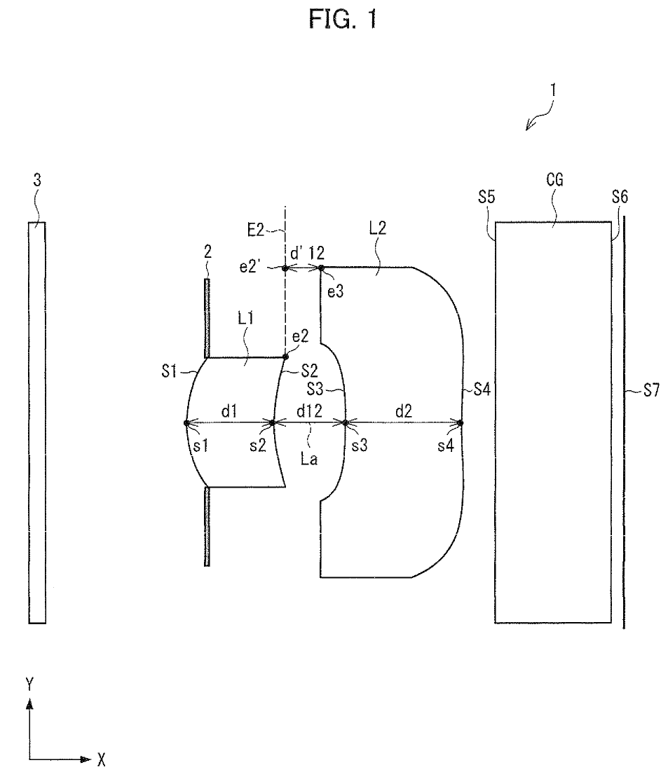

FIG. 1 illustrates a cross-section of an image pickup lens 1 whose plane has sides parallel with an X direction (lateral direction in FIG. 1) and a Y direction (perpendicular direction in FIG. 1). The X direction is a direction from an object 3 side toward an image surface S7 side. An optical axis La of the image pickup lens 1 is substantially parallel with the X direction. The Y direction is a direction perpendicular to the X direction. A normal direction with respect to the optical axis La is substantially parallel with the Y direction.

The image pickup lens 1 includes an aperture stop 2, a first lens L1, a second lens L2, and a cover glass (image surface protective glass) CG in this order from the object 3 side toward the image surface 57 side.

Specifically, the aperture stop 2 is provided around a surface S1 of the first lens L1 which surface S1 faces the object 3 side (an object-side surface of the first lens). In order that light incident upon the image pickup lens 1 may properly pass through the first lens L1 and the second lens L2, the aperture stop 2 serves to limit a diameter of an on-axis bundle of rays of the incident light.

The object 3 is a target whose image is formed by the image pickup lens 1. In other words, the object 3 is a subject whose image is taken by the image pickup lens 1.

The first lens L1 is a well-known meniscus lens which has a positive refracting power and whose surface S1 facing the object 3 is a convex surface. This leads to a high proportion of a whole length of the first lens L1 to a whole length of the image pickup lens 1. Accordingly, the image pickup lens 1 can have a long focal length as a whole, with respect to the whole length of the image pickup lens 1. This allows the image pickup lens 1 to be smaller in size and lower in height. The first lens L1 is arranged such that its surface S2 facing the image surface S7 (image-side surface of the first lens L1) may be a concave surface.

The second lens L2 is a lens which has a negative refracting power and whose surface (object-side surface of the second lens) S3 facing the object 3 is a concave surface. This makes it possible to realize a small Petzval sum (on-axis characteristic of a curvature of an image of a planar object due to an optical system), with maintenance of a refracting power of the second lens L2. As a result, astigmatism, a field curvature, and a coma aberration can be reduced.

That surface S4 of the second lens L2 which faces the image surface S7 (i.e., image-side surface of the second lens) has a concave central portion around a center s4, and a convex peripheral portion surrounding the concave central portion. That is, the surface S4 can be understood to have an inflection point which divides the surface S4 into a concave central portion and a convex peripheral portion. Accordingly, a ray of light that passes through the second lens L2 near the concave central portion can form an image in a position closer to the object 3 along the X direction. On the other hand, a ray of light that passes through the second lens L2 near the convex peripheral portion can form an image in a position closer to the image surface S7 along the X direction. This allows the image pickup lens 1 to correct various aberrations such as field curvatures by use of the concave shape and the convex shape of the surface S4 of the second lens L2.

The term “convex surface of a lens” refers to that spherical surface of the lens which curves outward. The term “concave surface of a lens” refers to that surface of the lens which curves so as to form a hollow, i.e., refers to that surface of the lens which curves inward.

Strictly speaking, the aperture stop 2 is formed so that the convex surface formed as a part of the surface S1 of the first lens L1 sticks out from the aperture stop 2 toward the object 3. However, there are no particular limits on whether or not the convex surface sticks out from the aperture stop 2 toward the object 3. It is sufficient for the aperture stop 2 to be provided closer to the object 3 than the first lens L1 is.

The cover glass CG is interposed between the second lens L2 and the image surface S7. The cover glass CG covers the image surface S7 in order to protect the image surface S7 from physical damage etc. The cover glass CG has a surface (object-side surface) S5 facing the object 3 and a surface (image-side surface) S6 facing the image surface S7.

The image surface S7 is a surface which is perpendicular to the optical axis La of the image pickup lens 1 and on which an image is formed. A real image can be observed on a screen (not illustrated) placed on the image surface S7. In an image pickup module having the image pickup lens 1, an image pickup device is provided to the image surface S7.

A distance d1 is a distance from a center s1 of the surface S1 to a center s2 of the surface S2. The distance d1 is equal to a center thickness of the first lens L1.

A distance d12 is a distance from the center s2 of the surface S2 to a center s3 of the surface S3. The distance d12 is equal to a distance from the image-side surface of the first lens L1 to the object-side surface of the second lens L2.

A distance d2 is a distance from the center s3 of the surface S3 to the center s4 of the surface 54. The distance d2 is equal to a center thickness of the second lens L2.

A distance d′12 is a clearance from an end e2 of the surface S2 to an end e3 of the surface S3 along the X direction. The distance d′12 is equal to a clearance from an end of the image-side surface of the first lens L1 to an end of the object-side surface of the second lens L2 along the X direction (i.e., distance along a direction of the optical axis La of the image pickup lens 1). More specifically, the distance d′12 is a length of a shortest line between the end e3 and a straight line E2 which extends from the end e2 in the Y direction. That is, the distance d′12 is a distance between the end e3 and a point e2′ which lies on the straight line E2 and is closest to the end e3.

Needless to say, the image pickup lens 1 is actually a three-dimensional object. Accordingly, the end e2 corresponds to an entire edge (e.g., circumference) of an effective aperture of the surface S2. Similarly, the end e3 corresponds to an entire edge (e.g., circumference) of an effective aperture of the surface S3. In this case, the distance d′12 is understood to be a clearance, along the X direction, from (i) the end e2 which is closest to the image surface S7 to (ii) the end e3 which is closest to the object 3.

Each of the distances d1, d12, d2, and d′12 is a distance along the X direction which distance is expressed in the unit mm (millimeter).

The image pickup lens 1 is arranged so as to satisfy the following formulas (1) and (2):

1.0<d1/d12<1.8 (1); and

0.1<d′12/(d1+d2) (2).

According to the arrangement, the image pickup lens 1 can satisfy the formula (1) so that a proportion of the distance d12 may be increased with respect to the distance d1. This makes it possible to increase a distance between the first lens L1 and the second lens L2.

In addition, the image pickup lens 1 can satisfy the formula (2) so that the proportion of the distance d′12 may be increased with respect to a sum of the distances d1 and d2. This makes it possible to secure a sufficiently long distance between the first lens L1 and the second lens L2 in that vicinity of the end e3 which corresponds to a space where respective edge portions of the first lens L1 and the second lens L2 are provided.

The arrangement makes it possible to easily provide both the edge portions in the image pickup lens 1. Furthermore, the provision of the edge portions allows the image pickup lens 1 to have a lower possibility of deterioration of an optical characteristic, and to have an arrangement suitable for reduction in manufacturing costs and for mass-production.

In a case where the variable “d1/d12” in the formula (1) is not more than 1.0, the image pickup lens 1 has a too long distance between the first lens L1 and the second lens L2. This is not preferable because this hinders the image pickup lens 1 from being smaller in size and lower in height. In a case where the variable “d1/d12” is not less than 1.8, the image pickup lens 1 has a too short distance between the first lens L1 and the second lens L2, as is the case with the image pickup lens disclosed in Patent Literature 2. This is not preferable because this impairs the ease of provision of the edge portions.

In a case where the variable “d′12/(d1+d2)” in the formula (2) is not more than 0.1, the image pickup lens 1 cannot secure a sufficiently long distance between the first lens L1 and the second lens L2 in the vicinity of the end e3. This is not preferable because this impairs the ease of provision of the edge portions.

Further, the image pickup lens 1 is arranged so as to satisfy the following formula (3):

0.2 mm<d′12 (3).

The arrangement is more preferable because the arrangement allows the image pickup lens 1 to secure, as described above, a sufficient space for providing the edge portions, and to secure a sufficient space for inserting a light-blocking plate etc. between the first lens L1 and the second lens L2.

In some cases, materials which can be adopted as materials for the first lens L1 and the second lens L2 can be limited depending on how the image pickup lens 1 is manufactured. Further, in general, an Abbe number of a lens is determined depending only on a property specific to a material (medium) of which the lens is made.

The image pickup lens disclosed in Patent Literature 2 satisfies the formula (B). This drastically limits materials which can be adopted as materials for the first lens L1 and which are required to have an Abbe number of more than 50. As a result, it can be difficult to adopt that material for the first lens L1 which is suitable for a wafer-level lens process.

In order to solve the problem, the image pickup lens 1 is preferably arranged such that an Abbe number v1 of the first lens L1 is more than 45, and an Abbe number v2 of the second lens L2 is more than 45.

Abbe number refers to that constant of an optical medium which indicates a ratio of a refractive index of light to a dispersivity of the light. In other words, an Abbe number is a degree to which rays of light of varying wavelengths are refracted in different directions. The higher the Abbe number of an optical medium, the lower the dispersivity corresponding to a degree to which rays of light of varying wavelengths are refracted in different directions.

The arrangement makes it possible to expand a range of allowable Abbe numbers from which the Abbe number v1 of the first lens L1 is selected. This increases the number of materials which can be adopted as materials for the first lens L1. This makes it possible to reduce a possibility that there arises a difficulty in adopting that material for the first lens L1 which is suitable for a wafer-level lens process. Therefore, the image pickup lens 1 thus arranged is further suitable for reduction in manufacturing costs and for mass-production.

Further, in a case where the image pickup lens 1 is arranged such that the Abbe number v1 of the first lens L1 is equal to the Abbe number v2 of the second lens L2, it is possible to use one same material in manufacturing both the first lens L1 and the second lens L2. This makes it possible to reduce manufacturing costs of the image pickup lens 1 so that an inexpensive image pickup lens may be realized.

Further, in a case where the cover glass CG is arranged to have a thickness of more than 0.3 mm, the image pickup lens 1 can relax its specification related to an allowable dust size and can protect the image surface S7 from physical damage. Protection of the image surface S7 from physical damage is advantageous in carrying out a wafer-level lens process.

The image pickup lens 1 is preferably arranged to have an F number of less than 4. F number is a kind of amount which indicates a luminance in an optical system. An F number of the image pickup lens 1 is expressed as a value obtained by dividing an equivalent focal length of the image pickup lens 1 by an incident pupil diameter of the image pickup lens 1. The image pickup lens 1 thus arranged can increase brightness of an image to be formed.

At least one of a material for the first lens L1 and that for the second lens L2 is preferably a thermosetting resin or a UV curable resin. The thermosetting resin is a resin having such a property that the resin changes from a liquid to a solid when a heat of not less than a predetermined amount is applied to the resin. The UV curable resin is a resin having such a property that the resin changes from a liquid to a solid when being irradiated with ultraviolet rays of not less than a predetermined intensity.

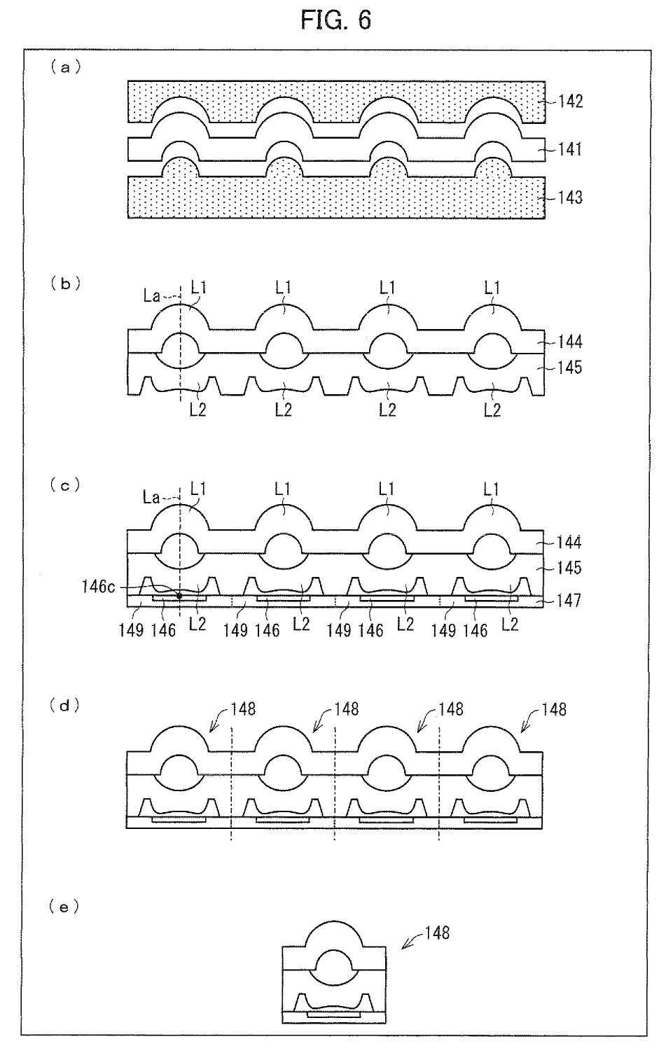

In a case where the first lens L1 is made from the thermosetting resin or the UV curable resin, it is possible to mold the resin into a plurality of first lenses L1 in a manufacturing process of the image pickup lens 1 so that an array of first lenses 144 (to be described later; see (b) of FIG. 6) can be manufactured. Likewise, in a case where the second lens L2 is made from the thermosetting resin or the UV curable resin, it is possible to mold the resin into a plurality of second lenses L2 in the manufacturing process of the image pickup lens 1 so that an array of second lenses 145 (to be described later; see (b) of FIG. 6) can be manufactured.

Thus, the arrangement makes it possible to manufacture the image pickup lens 1 in a wafer-level lens process. This realizes reduction in manufacturing costs, and mass-production. As a result, it becomes possible to provide the image pickup lenses 1 inexpensively.

Further, in a case where both the first lens L1 and the second lens L2 are made from the thermosetting resin or the UV curable resin, it is possible to subject the image pickup lens 1 to reflowing. In other words, the image pickup lens 1 which can be subjected to reflowing can be realized by adopting a heat-resistant material for both the first lens L1 and the second lens L2.

Alternatively, the first lens L1 and the second lens L2 can be made from plastic or glass.

Table 1 shows a concrete example of a formula for designing a lens system using the image pickup lens 1.

TABLE 1

| | | | | | Center | Effective | | | |
|---|---|---|---|---|---|---|---|---|---|
| Element | | | | Curvature | thickness | radius | Aspheric coefficient | | |
| Member | Nd | νd | Surface | [mm⁻¹] | [mm] | [mm] | K | A4 | A6 |
| L1 | 1.498 | 46 | S1 (Stop) | 1.16E+00 | 0.754 | 0.523 | 0.00E+00 | −6.63E−03 | 1.56E−01 |
| | | | S2 | 4.59E−01 | 0.013 | 0.633 | 0.00E+00 | 3.71E−01 | −2.32E+00 |
| L2 | 1.498 | 46 | S3 | −2.84E−01 | 0.997 | 0.657 | 0.00E+00 | −1.31E−01 | −3.48E+00 |
| | | | S4 | 8.92E−02 | 0.290 | 1.288 | 0.00E+00 | 2.15E−01 | −1.30E+00 |
| CG | 1.516 | 64 | S5 | — | 0.500 | — | — | — | — |
| | | | S6 | — | 0.050 | — | — | — | — |

| | | | | | | | |
|---|---|---|---|---|---|---|---|
| Image surface | S7 | — | 0.000 | 1.750 | — | — | — |

| Element | | | | Aspheric coefficient | | | | |
|---|---|---|---|---|---|---|---|---|
| Member | Nd | νd | Surface | A8 | A10 | A12 | A14 | A16 |
| L1 | 1.498 | 46 | S1 (Stop) | −1.43E+00 | 2.51E+00 | 3.16E+01 | −1.66E+02 | 2.37E+02 |
| | | | S2 | 2.35E+01 | −8.91E+01 | 4.17E+01 | 7.00E+02 | −1.31E+03 |
| L2 | 1.498 | 46 | S3 | 1.65E+01 | −3.44E+01 | −4.46E+01 | 2.88E+02 | −3.52E+02 |
| | | | S4 | 2.56E+00 | −2.91E+00 | 1.84E+00 | −6.04E−01 | 7.80E−02 |
| CG | 1.516 | 64 | S5 | — | — | — | — | — |
| | | | S6 | — | — | — | — | — |

| | | | | | | |
|---|---|---|---|---|---|---|
| Image surface | S7 | — | — | — | — | — |

In Table 1, the refractive index Nd and the Abbe number vd of each member are those obtained in a case where d-rays (wavelength of 587.6 nm) are applied to respective materials.

Center thickness (center thickness of a surface) refers to a distance between a center of a surface and a center of a corresponding surface toward the image surface along the optical axis La (see FIG. 1). Effective radius refers to a radius of a circular region in a lens where a range of a light beam can be limited.

Aspheric coefficient refers to an aspheric coefficient Ai of i-th order (where i is an even number of not less than 4) in the following formula (4), which is an aspheric formula for an aspheric surface. In the formula (4), Z is a coordinate on the optical axis (X direction in FIG. 1), x is a coordinate on a line normal to the optical axis (Y direction in FIG. 1), R is a curvature radius (inverse of a curvature), and K is a conic coefficient.

$$\begin{matrix}[ Formula 1 ] & \\ Z = \frac{{x}^{2} \times \frac{1}{R}}{1 + \sqrt{1 - ( 1 + K ) \times {x}^{2} \times \frac{1}{R}}} + {\sum }_{i = 4} {A}_{i} \times {x}^{i} & ( 4 )\end{matrix}$$

where i is an even number.

The description of values “(Constant a) E (Constant b)” in Table 1 represents “(Constant a)×10 raised to the power of (Constant b).” For example, “3.71E-01” represents “3.71×10⁻¹.”

Table 2 shows a concrete example of specifications of the image pickup lens 1.

TABLE 2

| | |
|---|---|
| F number | 2.8 |
| Image circle diameter/mm | 3.5 |
| Angle of view/deg | 60.2 |
| Sensor pixel pitch/μm | 2.2 |

According to Table 2, the image pickup lens 1 is arranged to have an F number of 2.8 which is less than 4.

The image circle diameter is an effective image circle size of an image resolved by the image pickup lens 1.

The angle of view is an angle at which the image pickup lens 1 can form an image.

The sensor pixel pitch is that pixel pitch of a sensor (solid-state image sensing device) which matches a characteristic of the image pickup lens 1. The sensor pixel pitch is preferably less than 2.5 μm. Provision of a sensor whose sensor pixel pitch is less than 2.5 μm makes it possible to realize an image pickup module which makes full use of the performance capabilities of an image pickup device having a large number of pixels. The image pickup lens 1 is arranged to have a sensor pixel pitch of 2.2 μm which is less than 2.5 μm.

Table 3 shows a concrete example of various optical characteristics of the image pickup lens 1.

TABLE 3

| | |
|---|---|
| Nd | 1.498 |
| νd | 46 |
| f/mm | 2.93 |
| f1/mm | 2.406 |
| f2/mm | −5.241 |
| R1/mm | 0.865 |
| d1/mm | 0.754 |
| d12/mm | 0.613 |
| d2/mm | 0.997 |
| d1/d12 | 1.230 |
| d′12/mm | 0.276 |

In Table 3, a refractive index Nd represents both a refractive index of the first lens L1 and that of the second lens L2.

In Table 3, an Abbe number vd represents both the Abbe number v1 of the first lens L1 and the Abbe number v2 of the second lens L2. As shown in Table 3, a value more than 45 is sufficient for the Abbe numbers v1 and v2. The Abbe numbers v1 and v2 are preferably equal to each other.

In Table 3, the focal length f represents a focal length of the image pickup lens 1; the focal length f1 represents a focal length of the first lens L1; and the focal length f2 represents a focal length of the second lens L2.

In Table 3, the curvature radius R1 represents a curvature radius of that surface S1 of the first lens L1 which faces the object 3.

Explanation of the distances d1, d12, d2, and d′12 in Table 3 is omitted since they are described in the foregoing explanation of FIG. 1.

In Table 3, the value “d1/d12” is a value obtained by dividing the distance d1 by the distance d12.

As shown in Table 3, the image pickup lens 1 is arranged such that the value d1/d12 is 1.230 which is found by the equation: 0.754 mm/0.613 mm=1.230. Thus, the formula (1) is satisfied. Further, as shown in Table 3, the image pickup lens 1 is arranged such that the distance d′12 is 0.276 mm. This satisfies the formula (3).

Substituting the distances d1 (0.754 mm), d2 (0.997 mm), and d′12 (0.276 mm) shown in Table 3 in the right side of the formula (2) results in a solution of approximately 0.158. This satisfies the formula (2).

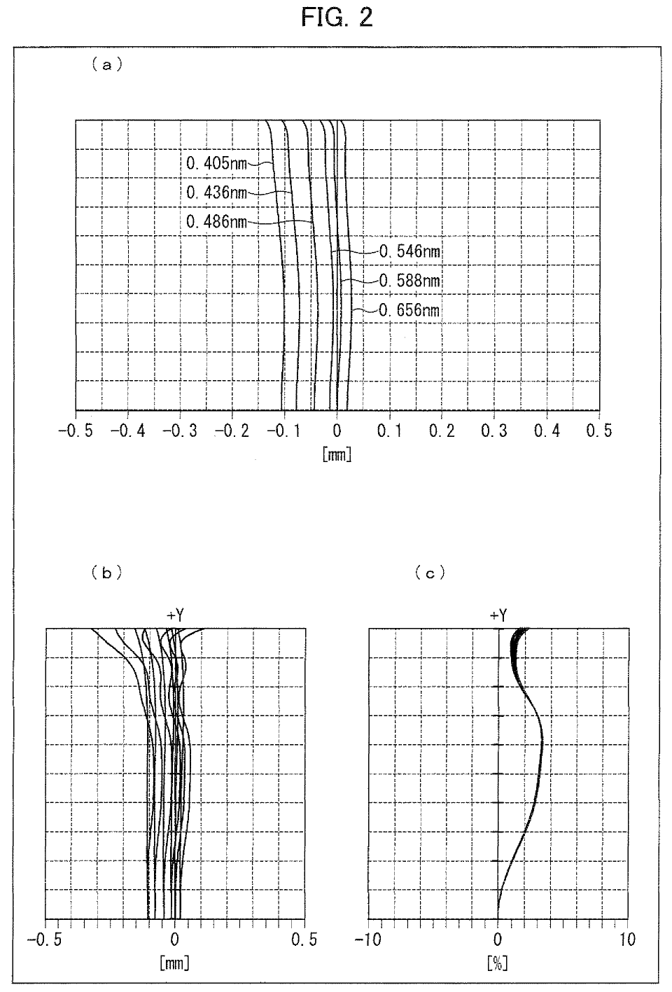

(a) to (c) of FIG. 2 are graphs showing characteristics of various aberrations of the image pickup 1. (a) of FIG. 2 shows a characteristic of a spherical aberration. (b) of FIG. 2 shows a characteristic of astigmatism. (c) of FIG. 2 shows a characteristic of a distortion.

The graphs show small amounts of remaining aberrations (small difference in magnitude of each aberration with respect to the displacements along the normal direction to the optical axis La, i.e., along the Y direction of FIG. 1). This shows that the image pickup lens 1 has good optical characteristics which are comparable with those of the image pickup lenses disclosed in Patent Literatures 1 and 2.

The spherical aberration shown in (a) of FIG. 2, the astigmatism shown in (b) of FIG. 2, and the distortion shown in (c) of FIG. 2 are the results of aberrations on a total of six types of incident light of different wavelengths of 405 nm, 436 nm, 486 nm, 546 nm, 588 nm, and 656 nm. Each of the graphs (a) and (b) shown in FIG. 2 shows aberrations at different wavelengths of 405 nm, 436 nm, 486 nm, 546 nm, 588 nm, and 656 nm, with the curves arranged in this order starting from the left on the drawing. In (b) of FIG. 2, those curves which are comparatively large in band of fluctuation along the horizontal axis represent aberrations with respect to the tangential surface, and those curves which are comparatively small in band of fluctuation along the horizontal axis represent aberrations with respect to the sagittal surface.

The term “sagittal surface” means the trajectory of an image point as formed in an optical system of rotational symmetry by a ray of light (sagittal ray), among rays of light coming from an object point off the optical axis of the optical system and entering the optical system, which is included in a plane (sagittal plane) perpendicular to a plane containing a chief ray and the optical axis. The term “tangential surface” means an image surface that is formed by a beam of light (bundle of meridional rays) perpendicular to a bundle of sagittal rays and including a chief ray. Since the terms “sagittal surface” and “tangential surface” are both commonly-used optical terms, they will not be further explained.

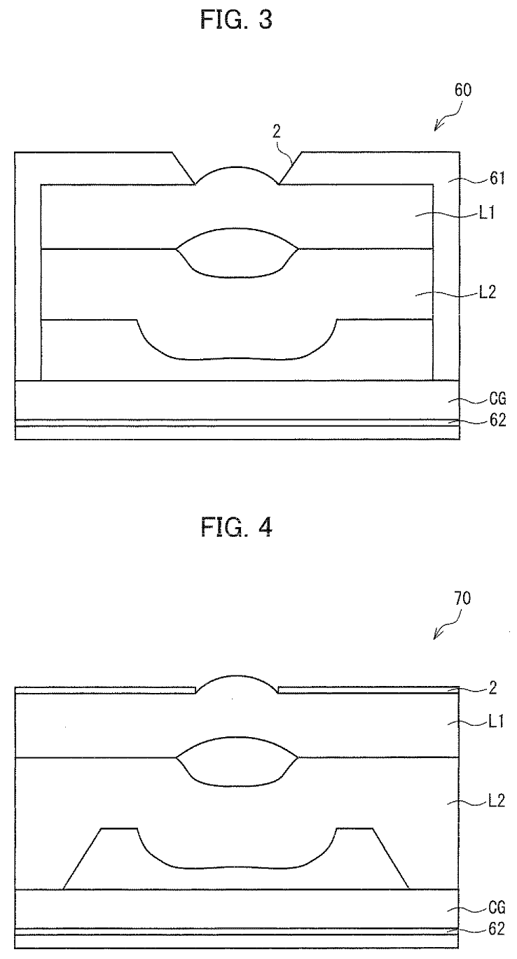

FIG. 3 is a cross-sectional view illustrating an arrangement of an image pickup module 60 having the image pickup lens 1 of the present invention.

Note that the first lens L1 and the second lens L2 of the image pickup lens 1 of FIG. 1 are partially illustrated in FIG. 3 for convenience of explanation. Specifically, FIG. 1 illustrates only their portions corresponding to respective effective apertures (i.e., illustrates their portions having no edge portions). However, the image pickup lens 1 and the image pickup module having the image pickup lens 1 are actually arranged such that the edge portions are provided to the peripheries of the effective apertures, as is the case with the image pickup module 60 of FIG. 3.

Therefore, strictly speaking, the distance d′12 of FIG. 1 is understood to be a clearance, along the X direction, between (i) the end e2 which is an end of the effective aperture of the surface S2 and (ii) the end, e3 which is an end of the effective aperture of the surface S3. In other words, the distance d″ 12 is understood to be equal to a clearance (distance along the direction of the optical axis of the image pickup lens 1) between (I) an end of the effective aperture on the image-side surface of the first lens L1 and (II) an end of the effective aperture on the object-side surface of the second lens L2. In addition to the understanding, it is understood that as a result of the provision of the edge portions to both the first lens L1 and the second lens L2, the edge portions can be bonded to each other as illustrated in FIG. 3, i.e., there can be no distance therebetween.

The arrangement in which the first lens L1 and the second lens L2 have respective edge portions is an arrangement for reducing a possibility of deterioration of an optical characteristic, and for easily realizing an image pickup lens and an image pickup module which are suitable for reduction in manufacturing costs and mass-production.

The image pickup module 60 of FIG. 3 includes the first lens L1, the second lens L2, the cover glass CG, a housing 61, and a sensor (solid-state image sensing device) 62. In the image pickup module 60, an aperture stop 2 is formed as a part of the housing 61. Specifically, the aperture stop 2 is formed so that the convex surface (corresponding to the surface S1 of FIG. 1) of the first lens L1 may be exposed upward from under the housing 61.

In other words, the image pickup module 60 is understood to include the image pickup lens 1 (see FIG. 1), the housing 61, and the sensor 62.

The housing 61 is a housing for housing the image pickup lens 1. The housing 61 is made from a light-blocking material. The cover glass CG is mounted on the sensor 62.

The sensor 62 is provided on the image surface S7 (see FIG. 1) of the image pickup lens 1. The sensor 62 is an image pickup device realized by a solid-state image sensing device such as a CCD image sensor or a CMOS image sensor. The use of a solid-state image sensing device as the sensor 62 allows the image pickup module 60 to be small in size and low in height. In particular, in image pickup modules 60 that are mounted into portable terminals (not shown) such as portable information terminals and portable phones, the use of solid-state image sensing devices in the sensors 62 makes it possible to realize image pickup modules that are high in resolving power, small in size, and low in height.

A pixel pitch of the sensor 62 is preferably equal to the sensor pixel pitch (see Table 2) of the image pickup lens 1. In this case, the pixel pitch of the sensor 62 is less than 2.5 μm. Adopting such a solid-state image sensing device allows the image pickup module 60 to make full use of the performance capabilities of the image pickup device having a large number of pixels.

The number of pixels which can be recorded by the sensor 62 is preferably 2 megapixels. In other words, the sensor 62 is preferably the so-called image pickup device of a 2M class. Providing the image pickup lens 1 in the image pickup module 60 having the image pickup device of the 2M class allows the image pickup module 60 to have fewer lenses. This makes it possible to reduce factors which can cause a manufacturing tolerance. This makes the manufacture easy.

Image pickup modules having image pickup devices of the 2M class heretofore have each mainly had an image pickup lens constituted by three lenses. Providing, in such an image pickup module having an image pickup device of the 2M class, the image pickup lens 1 constituted by two lenses (first lens L1 and second lens L2) allows the image pickup module to have fewer lenses although having a slightly lower resolution, as compared to a case where an image pickup lens constituted by three lenses is provided in the image pickup module. This makes it possible to reduce factors which can cause a manufacturing tolerance. This makes the manufacture easy.

The image pickup module 60 produces the same effect as the image pickup lens 1.

In addition, the image pickup lens 1 in the image pickup module 60 shows good values of various aberrations. For this reason, even if the image pickup module 60 does not include an adjustment mechanism (not illustrated) for adjusting the clearance between the image pickup lens 1 and the sensor 62, nor a body tube (not illustrated), the adverse effects on the maintenance of a high resolving power are small. The omission of the adjustment mechanism and the body tube allows the image pickup module 60 to be smaller in size, lower in height, and lower in cost.

Because the image pickup lens 1 has a broad permissible scope of manufacturing errors, the use of the image pickup lens 1 allows the image pickup module 60 to be constituted as a simple-structured image pickup module without a mechanism for adjusting the distance between the lens and the image surface.

An image pickup module 70 of FIG. 4 is an image pickup module obtained by omitting the housing 61 from the image pickup module 60 of FIG. 3. As a result, the image pickup module 70 has its aperture stop 2 so as to have substantially the same structure as the image pickup lens 1 of FIG. 1.

Further, the image pickup module 70 of FIG. 4 differs from the image pickup module 60 of FIG. 3 in that the edge portion corresponding to that surface of the second lens L2 which faces the sensor 62 (the surface corresponds to the surface S4 shown in FIG. 1) is placed on the cover glass CG. The cover glass CG is placed on the sensor 62.

The image pickup module 70 does not need to have a housing 61 for housing the image pickup lens 1. The omission of the housing 61 allows the image pickup module 70 to be further smaller in size, further lower in height, and further lower in cost.

The image pickup module 70 is based on the image pickup module 60 structured not to include an adjustment mechanism (not shown) or a body tube (not shown). Furthermore, the image pickup lens 1 of the image pickup module 70 has a very small clearance between the lower surface of the second lens L2 and the cover glass CG. The image pickup module 70 makes a simple-structured image pickup module 70 without the need for a housing 61 by forming the second lens L2 integrally with a portion for installation on the cover glass CG with a small deviation ratio of thickness of the lens.

In other respects, the image pickup module 70 is arranged similarly to the image pickup module 60.

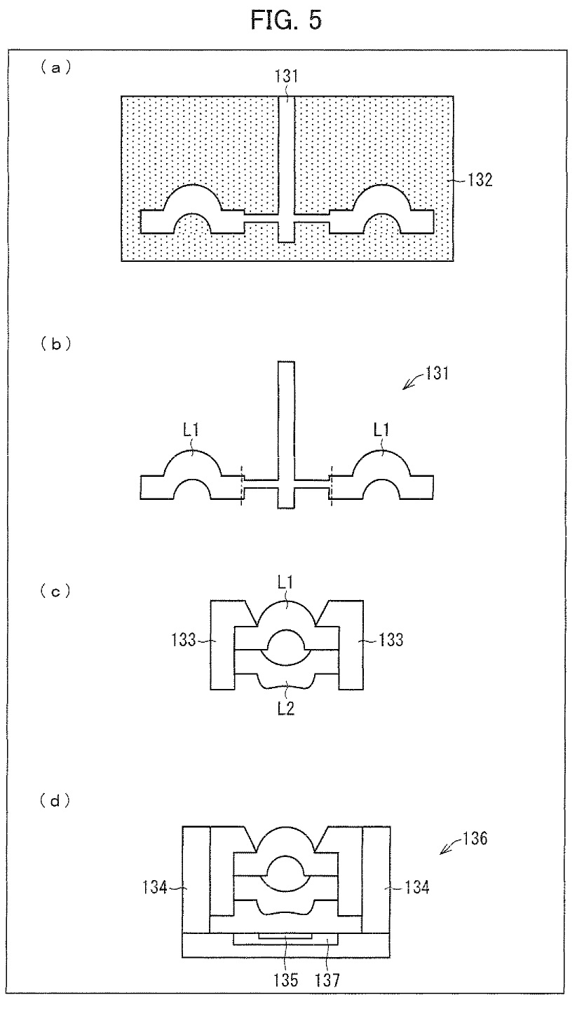

The following describes one method for manufacturing an image pickup lens and an image pickup module, with reference to (a) through (d) of FIG. 5.

The first lens L1 and the second lens L2 are produced mainly by injection molding with thermoplastic resin 131. In this process, the thermoplastic resin 131 softened by heat is forced into a mold 132 at a predetermined injection pressure (approximately 10 to 3,000 kgf/c) so that the mold 132 may be filled with the thermoplastic resin 131 (see (a) of FIG. 5). Although (a) of FIG. 5 illustrates only the molding of the first lens L1 for convenience of explanation, a person skilled in the art can also easily perform the molding of the second lens L2 in the same manner by using the mold 132. In this case, it is necessary for the mold 132 to have a shape in accordance with the second lenses L2.

The thermoplastic resin 131 molded into a plurality of first lenses L1 is taken out from the mold 132, and then divided into individual first lenses L1 (see (b) of FIG. 5). Similarly, the thermoplastic resin 131 molded into a plurality of second lenses L2 is taken out from the mold 132, and then divided into individual second lenses L2, although this is not illustrated for convenience of explanation.

A first lens L1 and a second lens L2 are fitted or pressed into a lens barrel (housing) 133 for assembly (see (c) of FIG. 5). The aperture stop 2 (see FIG. 1) is formed so as to have the same structure of the one in the image pickup module 60 of FIG. 3.

A semifinished product shown in (c) of FIG. 5, which is a product in a stage prior to the completion of an image pickup module 136, is fitted into a body tube 134 for assembly. After that, a sensor 137 in which a cover glass 135 is attached to a light-receiving section is mounted on the image surface S7 (see FIG. 1) of the image pickup lens 1 constituted by the first lens L1 and the second lens L2. Thus, the image pickup module 136 is completed (see (d) of FIG. 5).

The thermoplastic resin 131, of which the first lens L1 and the second lens L2, i.e. the injection molded lenses, are made, has a deflection temperature under loading (heat distortion temperature) of approximately 130° C. For this reason, the thermoplastic resin 131 is insufficient in resistance to a thermal history (whose maximum temperature is approximately 260° C.) during execution of reflowing, which is a technique that is applied mainly to surface mounting. Therefore, the thermoplastic resin 131 cannot resist heat that is generated during reflowing.

Consequently, before the image pickup module 136 is mounted onto a substrate, only the sensor 135 section is mounted by reflowing. After that, a method of joining the first lens L1 and second lens L2 section with resin or a mounting method of locally heating the area where the first lens L1 and second lens L2 are mounted is adopted.

(d) of FIG. 5 illustrates a rectangle in the sensor 137, as the cover glass 135 included in the sensor 137. In each of the image pickup modules 60 and 70 (see FIGS. 3 and 4), the cover glass CG is attached onto substantially the entire surface of the sensor 62 on the second lens L2 side. In the image pickup module 136, by contrast, the cover glass 135 is attached only onto the light-receiving section of the sensor 137.

The following describes another method for manufacturing an image pickup lens and an image pickup module, with reference to (a) through (e) of FIG. 6. The method corresponds to the wafer-level lens process.

Recent years, the development of a so-called heat-resistant camera module whose first lens L1 and/or second lens L2 is/are made from thermosetting resin or UV curable resin has been advanced. The image pickup module 148 described here is such a heat-resistant camera module whose first lens L1 and second lens L2 are made from thermosetting resin (molding material) 141, instead of being made from the thermoplastic resin 131 (see (a) of FIG. 5). Instead of the thermosetting resin 141, the UV curable resin can be adopted.

When the first lens L1 and/or second lens L2 is/are made from the thermosetting resin 141 or the UV curable resin, the cost of manufacturing image pickup modules 148 can be reduced by batch-manufacturing a large number of image pickup modules 148 in a short time. In particular, when the first lens L1 and second lens L2 are made from the thermosetting resin 141 or the UV curable resin, reflowing can be performed on image pickup modules 148.

There have been proposed various techniques for manufacturing image pickup modules 148. Of these techniques, the aforementioned injection molding and the wafer-level lens process are representative. In particular, the wafer-level lens (reflowable lens) process has recently drawn attention as being more advantageous in terms of the time that it takes to manufacture image pickup modules and other comprehensive knowledge.

In the execution of the wafer-level lens process, it is necessary to prevent the first lens L1 and the second lens L2 from suffering from plastic deformation due to heat. Because of this necessity, wafer-level lenses (lens array) made from a highly heat-resistant thermosetting resin material or UV curable resin material that resists deformation even under heat have drawn attention as the first lens L1 and the second lens L2. Specifically, wafer-level lenses made from such a heat-resistant thermosetting resin material or UV curable resin material that does not suffer from plastic deformation even under heat of 260 to 280° C. for ten seconds or longer have drawn attention. According to the wafer-level lens process, image pickup modules 148 are manufactured as below. The thermosetting resin 141 is molded into an array of first lenses 144 and an array of second lenses 145 in a manner of batch-molding by use of lens array-shaped molds 142 and 143, respectively. Then, the array of first lenses 144 and the array of second lenses 145 are bonded to each other. Further, an array of sensors 147 is mounted thereon. Finally, the resulting product is divided into individual image pickup modules 148.

The following describes details of the wafer-level lens process.

In the wafer-level lens process, an array of lenses is produced as below. First, the thermosetting resin 141 is sandwiched between the lens array-shaped mold 142, which has a large number of concavities formed therein, and the lens array-shaped mold 143, which has a large number of convexities which are formed therein so as to correspond to the concavities. Then, the thermosetting resin 141 is cured by heat generated by the lens array-shaped molds 142 and 143. Thus, an array of lenses is manufactured which has lens portions each in the same form as a combination of one of the concavities and a corresponding one of the convexities (see (a) of FIG. 6).

The arrays of lenses that are produced in the step shown in (a) of FIG. 6 are the array of first lenses 144, which has been molded from the thermosetting resin 141 so as to have portions as a large number of first lenses L1, and the array of second lenses 145, which has been molded from the thermosetting resin 141 so as to have portions as a large number of second lenses L2.

In manufacturing the array of first lenses 144 by using the lens array-shaped molds 142 and 143, the step of (a) of FIG. 6 is carried out by use of (i) the lens array-shaped mold 142 having a large number of concavities each of which has a symmetrical shape to the surface S1 (see FIG. 1) of the first lens L1, and (ii) the lens array-shaped mold 143 having a large number of convexities each of which has a symmetrical shape to the surface S2 (see FIG. 1) of the first lens L1.

In manufacturing the array of second lenses 145 by using lens array-shaped molds 142 and 143, the step of (a) of FIG. 6 is carried out by use of (i) the lens array-shaped mold 142 having a large number of portions each of which has a symmetrical shape (i.e., such a shape that a portion corresponding to the central portion of the surface S4 is convex and a portion corresponding to the peripheral portion of the surface S4 is concave) to the surface S4 (see FIG. 1) of the second lens L2, and (ii) the lens array-shaped mold 143 having a large number of convexities each of which has a symmetrical shape to the surface S3 (see FIG. 1) of the second lens L2. This is not illustrated for convenience of explanation.

The array of first lenses 144 and the array of second lenses 145 are bonded to each other so that both an optical axis of each first lens L1 and an optical axis of a corresponding second lens L2 may match the optical axis (one same straight line) La of the image pickup lens 1 of FIG. 1 (see (b) of FIG. 6).

In addition to this method, methods for alignment between the array of first lenses 144 and the array of second lenses 145 encompass various methods such as performing the alignment while capturing images. The alignment is affected by the pitch precision with which the wafer is finished.

In this process, an array of aperture stops (not illustrated), which integrally has a large number of aperture stops 2, can be attached to the array of first lenses 144 so that those convexities of the array of first lenses 144 may be exposed which correspond to surfaces S1 (see FIG. 1) of the first lenses L1. Alternatively, one aperture stop 2 can be attached to each of the first lenses L1. When and how the aperture stop(s) 2 is attached is not particularly limited.

Then, the array of sensors 147, which integrally has a large number of sensors 149, is mounted onto that product of (b) of FIG. 6 in which the array of first lenses 144 and the array of second lenses 145 have been bonded to each other (see (c) of FIG. 6). Specifically, the array of sensors 147 is mounted onto the product so that each optical axis La is aligned with a center 146c of a corresponding sensor 149. Each sensor 149 is placed on the image surface S7 (see FIG. 1) of a corresponding image pickup lens 1. Further, a cover glass 146 is attached to the light-receiving section of each sensor 149.

In the step shown in (c) of FIG. 6, the array of a large number of image pickup modules 148 is divided into individual image pickup modules 148 (see (d) of FIG. 6), whereby the image pickup module 148 is completed (see (e) of FIG. 6).

(c) of FIG. 6 illustrate a rectangle in each sensor 149, as the cover glass 146 included in each sensor 149. In each of the image pickup modules 60 and 70 (see FIGS. 3 and 4), the cover glass CG is attached onto substantially the entire surface of the sensor 62 on the second lens L2 side. In the image pickup module 148, by contrast, a cover glass 146 is attached only onto the light-receiving section of each sensor 149.

In a case where the process, illustrated in (c) of FIG. 6, of providing the sensors 149 (array of sensors 147) is omitted, and only the cover glasses 146 are provided so that an image pickup device may be omitted from each image pickup module 148, it is possible to manufacture the image pickup lenses in a wafer-level lens process.

When and how the cover glasses 135 and 146 are provided is not particularly limited. Thus, a cover glass (image surface protective glass) can be provided to the image pickup lens of the present invention or the image pickup module of the present invention in a manner illustrated in FIGS. 3 and 4 or in a manner illustrated in (d) of FIG. 5 and (e) of FIG. 6.

The image pickup module 148 thus manufactured can be the image pickup module 70 of FIG. 4. The image pickup lens thus manufactured can be the image pickup lens 1 of FIG. 1.

According to the wafer-level lens process shown above in (a) through (e) of FIG. 6, the cost of manufacturing image pickup modules 148 can be reduced by batch-manufacturing a large number of image pickup modules 148. Furthermore, in order to prevent the first lens L1 and the second lens L2 from suffering from plastic deformation due to heat (whose highest temperature is approximately 260° C.) that is generated by reflowing in mounting a completed image pickup module 148 on a substrate (not shown), it is more preferable that the first lens L1 and the second lens L2 be made from a heat-resistant thermosetting resin material or UV curable resin material that is resistant to heat of 260 to 280° C. for ten seconds or longer. This makes it possible to perform reflowing on the image pickup module 148. The application of a heat-resistant resin material to the wafer-level manufacturing steps makes it possible to inexpensively manufacture image pickup modules on which reflowing can be performed.

The following looks at materials, suitable to manufacturing image pickup modules 148, of which first lenses L1 and second lenses L2 can be made.

Thermoplastic resin materials have been mainly used as materials for plastic lenses; therefore, there is a wide range of materials.

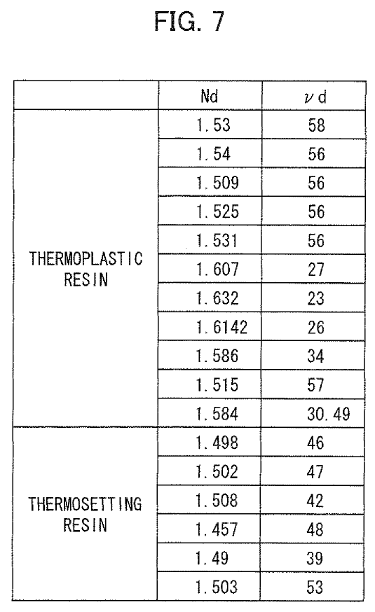

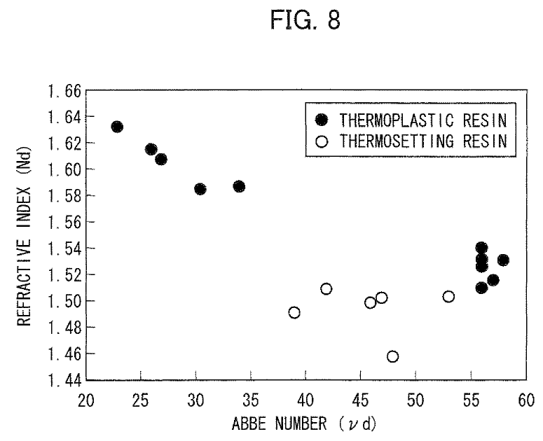

On the other hand, thermosetting resin materials and UV curable resin materials have not been fully developed for use as first lenses L1 or second lenses L2 and, as such, are currently inferior to the thermoplastic resin materials in diversity and optical constant, and expensive. In general, the optical constant of a material with a low refractive index and low dispersivity is preferable. Further, it is preferable that there be a wide range of optical constants to choose from in optical design (see FIGS. 7 and 8).

Further, the image pickup lens of the present invention is arranged so as to satisfy the following formula (3):

0.2 mm<d′12 (3).

The arrangement makes it possible to secure a sufficient space for providing the respective edge portions of the first lens and the second lens, and to secure a sufficient space for inserting a light-blocking plate etc. between the first lens and the second lens.

In some cases, materials which can be adopted as materials for the first lens and the second lens can be limited depending on how the image pickup lens is manufactured. Further, in general, an Abbe number of a lens is determined depending only on a property specific to a material of which the lens is made.

The image pickup lens disclosed in Patent Literature 2 satisfies the formula (B). This drastically limits materials which can be adopted as materials for the first lens and which are required to have a very high Abbe number. As a result, it can be difficult to adopt that material for the first lens which is suitable for a wafer-level lens process.

In view of this, the image pickup lens of the present invention is arranged such that: the first lens has an Abbe number of more than 45; and the second lens has an Abbe number of more than 45.

The arrangement makes it possible to expand a range of allowable Abbe numbers from which the Abbe number of the first lens is selected. This increases the number of materials which can be adopted as materials for the first lens. This makes it possible to reduce a possibility that there arises a difficulty in adopting that material for the first lens which is suitable for a wafer-level lens process. Therefore, the image pickup lens thus arranged is further suitable for reduction in manufacturing costs and for mass-production.

Further, the image pickup lens of the present invention is arranged such that the Abbe number of the first lens is equal to the Abbe number of the second lens.

This makes it possible to use one same material in manufacturing both the first lens and the second lens. This makes it possible to reduce manufacturing costs of the image pickup lens so that an inexpensive image pickup lens may be realized.

Further, the image pickup lens of the present invention further includes: an image surface protective glass for protecting the image surface, the image surface protective glass being provided between the image surface and the second lens, the image surface protective glass having a thickness of more than 0.3 mm.

The arrangement makes it possible to relax a specification related to an allowable dust size, and to protect the image surface from physical damage. Protection of the image surface from physical damage is advantageous in carrying out a wafer-level lens process.

Further, the image pickup lens of the present invention has an F number of less than 4.

The arrangement makes it possible to realize an image pickup lens which forms a bright image.

Further, the image pickup lens of the present invention is arranged such that at least one of the first lens and the second lens is made from a resin which is cured with heat or ultraviolet rays.

According to the arrangement, the first lens is made from thermosetting resin or UV (Ultra-Violet) curable resin. This makes it possible to mold the resin into a plurality of first lenses so that the aforementioned array of first lenses can be manufactured. Similarly, according to the arrangement, the second lens is made from the thermosetting resin or the UV (Ultra-Violet) curable resin. This makes it possible to mold the resin into a plurality of second lenses so that the aforementioned array of second lenses can be manufactured.

Thus, the arrangement makes it possible to manufacture the image pickup lens in a wafer-level lens process. This realizes reduction in manufacturing costs, and mass-production. As a result, it becomes possible to provide the image pickup lenses inexpensively.

Further, in a case where both the first lens and the second lens are made from the thermosetting resin or the UV curable resin, it is possible to subject the image pickup lens to reflowing. In other words, the image pickup lens which can be subjected to reflowing can be realized by adopting a heat-resistant material for both the first lens and the second lens.

Further, the image pickup module of the present invention is arranged such that a pixel pitch of the solid-state image sensing device is less than 2.5 μm.

According to the arrangement, a solid-state image sensing device whose sensor pixel pitch is less than 2.5 μm is adopted for the image pickup module. This makes it possible to realize an image pickup module which, makes full use of the performance of an image pickup device having a large number of pixels.

Further, the image pickup module of the present invention is arranged such that the number of pixels which can be recorded by the solid-state image sensing device is 2 megapixels.

According to the arrangement, the image pickup lens is provided in the image pickup module having the solid-state image sensing device of the 2M class. This allows the image pickup module to have fewer lenses. This makes it possible to reduce factors which can cause a manufacturing tolerance. This makes the manufacture easy.

Further, the method of the present invention for manufacturing an image pickup lens, and the method of the present invention for manufacturing an image pickup module are arranged such that the molding material is a resin which is cured with heat or ultraviolet rays.

The arrangement makes it possible to subject, to reflowing, the image pickup lens and the image pickup module which are manufactured by respective methods. Further, the arrangement makes it possible to easily manufacture an array of lenses by molding a molding material into a plurality of lenses.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

### INDUSTRIAL APPLICABILITY

The present invention is suitably applicable to an image pickup lens and an image pickup module that are to be provided in a portable terminal; a method for manufacturing an image pickup lens; and a method for manufacturing an image pickup module.

### REFERENCE SIGNS LIST

1 Image pickup lens
2 Aperture stop
3 Object
60, 70, 136, and 148 Image pickup module
62, 135, and 146 Sensor (solid-state image sensing device)
141 Thermosetting resin (molding material)
144 Array of first lenses
145 Array of second lenses
CG Cover glass (image surface protective glass)
d1 A distance between a center of that surface of a first lens which faces an object and a center of that surface of the first lens which faces an image surface
d12 A distance between the center of that surface of the first lens which faces the image surface and a center of that surface of the second lens which faces the object
d2 A distance between the center of that surface of the second lens which faces the object and a center of the surface of the second lens which faces the image surface
d′12 A clearance, along an optical axis of the image pickup lens, between an end of that surface of the first lens which faces the image surface and an end of that surface of the second lens which faces the object
e2 The end of that surface of the first lens which faces the image surface
e3 The end of that surface of the second lens which faces the object
L1 First lens
L2 Second lens
La Optical axis of the image pickup lens
S1 The surface of the first lens which surface faces the object
s1 The center of that surface of the first lens which faces the object
S2 The surface of the first lens which surface faces the image surface
s2 The center of that surface of the first lens which faces the image surface
S3 The surface of the second lens which surface faces the object
s3 The center of that surface of the second lens which faces the object
S4 The surface of the second lens which surface faces the image surface
s4 The center of that surface of the second lens which faces the image surface
S7 Image surface

1. An image pickup lens comprising:
an aperture stop;
a first lens; and
a second lens,
the aperture stop, the first lens, and the second lens being arranged in this order along a direction from an object to an image surface,
the first lens being a meniscus lens having a positive refracting power and having a convex surface facing the object,
the second lens being a lens having a negative refracting power and having a concave surface facing the object,
the second lens having a surface facing the image surface, the surface including a concave central portion and a convex peripheral portion surrounding the concave central portion,
said image pickup lens satisfying formulas (1) and (2):
1.0<d1/d12<1.8 (1); and
0.1<d′12/(d1+d2) (2)
where:
d1 is a distance between a center of that convex surface of the first lens which faces the object and a center of that surface of the first lens which faces the image surface;
d12 is a distance between the center of that surface of the first lens which faces the image surface and a center of that concave surface of the second lens which faces the object;
d2 is a distance between the center of that concave surface of the second lens which faces the object and a center of that surface of the second lens which faces the image surface; and
d′12 is a clearance, along a direction of an optical axis of the image pickup lens, between an end of that surface of the first lens which faces the image surface and an end of that concave surface of the second lens which faces the object.

2. The image pickup lens as set forth in claim 1 satisfying a formula (3):
0.2 mm<d′12 (3).

3. The image pickup lens as set forth in claim 1, wherein:
the first lens has an Abbe number of more than 45; and
the second lens has an Abbe number of more than 45.

4. The image pickup lens as set forth in claim 1, wherein the Abbe number of the first lens is equal to the Abbe number of the second lens.

5. The image pickup lens as set forth in claim 1, further comprising: an image surface protective glass for protecting the image surface, the image surface protective glass being provided between the image surface and the second lens,
the image surface protective glass having a thickness of more than 0.3 mm.

6. The image pickup lens as set forth in claim 1, having an F number of less than 4.

7. The image pickup lens as set forth in claim 1, wherein at least one of the first lens and the second lens is made from a resin which is cured with heat or ultraviolet rays.

8. An image pickup module comprising:
an image pickup lens; and
a solid-state image sensing device provided on an image surface of the image pickup lens,
said image pickup lens including:
an aperture stop;
a first lens; and
a second lens,
the aperture stop, the first lens, and the second lens being arranged in this order along a direction from an object to the image surface,
the first lens being a meniscus lens having a positive refracting power and having a convex surface facing the object,
the second lens being a lens having a negative refracting power and having a concave surface facing the object,
the second lens having a surface facing the image surface, the surface including a concave central portion and a convex peripheral portion surrounding the concave central portion,
said image pickup lens satisfying formulas (1) and (2):
1.0<d1/d12<1.8 (1); and
0.1<d′12/(d1+d2) (2)
where:
d1 is a distance between a center of that convex surface of the first lens which faces the object and a center of that surface of the first lens which faces the image surface;
d12 is a distance between the center of that surface of the first lens which faces the image surface and a center of that concave surface of the second lens which faces the object;
d2 is a distance between the center of that concave surface of the second lens which faces the object and a center of that surface of the second lens which faces the image surface; and
d′12 is a clearance, along a direction of an optical axis of the image pickup lens, between an end of that surface of the first lens which faces the image surface and an end of that concave surface of the second lens which faces the object.

9. The image pickup module as set forth in claim 8, wherein a pixel pitch of the solid-state image sensing device is less than 2.5 μm.

10. The image pickup module as set forth in claim 8, wherein the number of pixels which can be recorded by the solid-state image sensing device is 2 megapixels.

11. A method for manufacturing an image pickup lens, the image pickup lens including:
an aperture stop;
a first lens; and
a second lens,
the aperture stop, the first lens, and the second lens being arranged in this order along a direction from an object to an image surface,
the first lens being a meniscus lens having a positive refracting power and having a convex surface facing the object,
the second lens being a lens having a negative refracting power and having a concave surface facing the object,
the second lens having a surface facing the image surface, the surface including a concave central portion and a convex peripheral portion surrounding the concave central portion,
said image pickup lens satisfying formulas (1) and (2):
1.0<d1/d12<1.8 (1); and
0.1<d′12/(d1+d2) (2)
where:
d1 is a distance between a center of that convex surface of the first lens which faces the object and a center of that surface of the first lens which faces the image surface;
d12 is a distance between the center of that surface of the first lens which faces the image surface and a center of that concave surface of the second lens which faces the object;
d2 is a distance between the center of that concave surface of the second lens which faces the object and a center of that surface of the second lens which faces the image surface; and
d′12 is a clearance, along a direction of an optical axis of the image pickup lens, between an end of that surface of the first lens which faces the image surface and an end of that concave surface of the second lens which faces the object,
said method comprising the steps of:
molding a piece of a molding material into an array of first lenses, the array having portions molded as a plurality of the first lenses;
molding another piece of the molding material into an array of second lenses, the array having portions molded as a plurality of the second lenses;
bonding the array of first lenses to the array of second lenses so that an optical axis of each of the plurality of the first lenses and an optical axis of a corresponding one of the plurality of the second lenses may match one same straight line; and
dividing the array of first lenses and the array of second lenses thus bonded to each other into separate image pickup lenses.

12. The method as set forth in claim 11, wherein the molding material is a resin which is cured with heat or ultraviolet rays.

13. A method for manufacturing an image pickup module, the image pickup module including:
an image pickup lens; and
a solid-state image sensing device provided on an image surface of the image pickup lens,
said image pickup lens including:
an aperture stop;
a first lens; and
a second lens,
the aperture stop, the first lens, and the second lens being arranged in this order along a direction from an object to the image surface,
the first lens being a meniscus lens having a positive refracting power and having a convex surface facing the object,
the second lens being a lens having a negative refracting power and having a concave surface facing the object,
the second lens having a surface facing the image surface, the surface including a concave central portion and a convex peripheral portion surrounding the concave central portion,
said image pickup lens satisfying formulas (1) and (2):
1.0<d1/d12<1.8 (1); and
0.1<d′12/(d1+d2) (2)
where:
d1 is a distance between a center of that convex surface of the first lens which faces the object and a center of that surface of the first lens which faces the image surface;
d12 is a distance between the center of that surface of the first lens which faces the image surface and a center of that concave surface of the second lens which faces the object;
d2 is a distance between the center of that concave surface of the second lens which faces the object and a center of that surface of the second lens which faces the image surface; and
d′12 is a clearance, along a direction of an optical axis of the image pickup lens, between an end of that surface of the first lens which faces the image surface and an end of that concave surface of the second lens which faces the object,
said method comprising the steps of:
molding a piece of a molding material into an array of first lenses, the array having portions molded as a plurality of the first lenses;
molding another piece of the molding material into an array of second lenses, the array having portions molded as a plurality of the second lenses;
bonding the array of first lenses to the array of second lenses so that an optical axis of each of the plurality of the first lenses and an optical axis of a corresponding one of the plurality of the second lenses may match one same straight line; and
dividing the array of first lenses and the array of second lenses thus bonded to each other into separate image pickup modules.

14. The method as set forth in claim 13, wherein the molding material is a resin which is cured with heat or ultraviolet rays.
